(19) United States
(12) Patent Application Publication
(10) Pub. No.: US 2025/0041711 A1
(43) Pub. Date: Feb. 6, 2025

(54) Integrated Display and Wireless Reader Interactive Device

(71) Applicant: Beat The Bomb

(72) Inventor: Alexander B. Patterson, Brooklyn, NY (US)

(21) Appl. No.: 18/795,012

(22) Filed: Aug. 5, 2024

Related U.S. Application Data
(60) Provisional application No. 63/530,937, filed on Aug. 4, 2023.
(60) Provisional application No. 63/543,892, filed on Oct. 12, 2023.
(60) Provisional application No. 63/543,697, filed on Oct. 11, 2023.

(51) Int. Cl. A63F 13/235; A63F 13/2145; A63F 13/90

(52) U.S. Cl. CPC A63F 13/235; A63F 13/2145; A63F 13/90; A63F 2300/1031; A63F 2300/1043

(57) ABSTRACT

Embodiments of the present disclosure relate to interactive game room devices comprising a case, a processor, a wireless sensor, a display, a communication port, and other optional elements. The communication port can be coupled to a game logic. The wireless reader can be utilized to facilitate wireless communication and interaction with various devices and systems. The processor can enable executing of game logic or display drivers, while the wireless sensor can allow for the detection and measurement of wireless signals. The communication port, coupled to a game logic, can allow for seamless integration with various elements within a game room. The wireless sensor can be configured to interact with wearable devices, such as bracelets that are configured with wireless transceivers including, but not limited to, radio frequency identification devices. Multiple interactive game room devices can be deployed within a single game room to facilitate game play.

### PRIORITY

This application claims the benefit of and priority to U.S. Provisional Application, entitled “Mobile Gaming Unit System,” filed on Aug. 4, 2023 and having application Ser. No. 63/530,937; U.S. Provisional Application No. 63/543,892 filed on Oct. 12, 2023, entitled “Interactive Wireless Reader”; and U.S. Provisional Application No. 63/543,697 filed on Oct. 11, 2023, entitled “Integrated Display and Wireless Reader Interactive Device, the entirety of said applications are being incorporated herein by reference.

The present disclosure relates to interactive gaming. More particularly, the present disclosure relates to utilizing an interactive game room device for interactive play.

### BACKGROUND

Previous approaches to wireless readers have typically involved separate components and limited functionality. Conventional wireless readers have consisted of a case housing various components, including a processor, a wireless sensor, illumination devices, and a communication port. These components have been individually integrated into the case, but have not been effectively combined to provide a comprehensive solution.

In some existing wireless readers, the case serves as a protective housing for the internal components. The processor is responsible for executing instructions and controlling the operation of the wireless reader. The wireless sensor is used to detect and capture wireless signals, enabling communication with external devices. Illumination devices are incorporated to provide adequate lighting for scanning or reading purposes. The communication port is typically used to establish a connection with external devices, such as computers or mobile devices. However, these conventional wireless readers have not fully integrated the functionality of these components to provide a seamless and efficient user experience.

Other approaches have attempted to incorporate game logic into wireless readers to enhance user engagement and interaction. Game logic refers to the rules and algorithms that govern the operation of a game. By coupling the communication port of a wireless reader to game logic, users can enjoy interactive gaming experiences. However, these previous approaches have not fully optimized the integration of the communication port with the game logic, resulting in limited functionality and suboptimal user experiences.

In summary, previous approaches to wireless readers have involved separate components housed within a case, including a processor, a wireless sensor, illumination devices, and a communication port. However, none of these approaches have provided a comprehensive solution that combines the features described in this disclosure, including the integration of game logic with the communication port, to create an efficient and engaging wireless reader.

### SUMMARY OF THE DISCLOSURE

Systems and methods for utilizing an interactive game room device for interactive play in accordance with embodiments of the disclosure are described herein.

In some embodiments, an interactive game room device, includes a wireless reader including a case, a processor, a wireless sensor, a plurality of illumination devices, and a communication port, wherein the communication port is coupled to a game logic, and a display, wherein the display is configured to interact with the game logic to display one or more current game states associated with the game logic on the display.

In some embodiments, the game logic is configured to execute a game mode, receive identification data associated with a wireless device, determine a player association based on the received identification data, adjust a game state based on the determined player association, and direct the display to indicate the adjusted game state.

In some embodiments, the identification data is received from the wireless sensor.

In some embodiments, the wireless sensor receives the identification data in response to an interaction with the wireless device.

In some embodiments, the wireless device is a wearable device.

In some embodiments, the wearable device is a wristband.

In some embodiments, an interactive game room device, wherein the game logic is configured to receive game data, generate a current game mode, direct the display to indicate the current game mode, receive wireless signal data, parse the wireless signal data for identification data, validate the identification data, update the game mode based on the validated identification data, and direct the display to indicate the updated game mode.

In some embodiments, the wireless signal data is received from the wireless sensor in response to an interactive with a wearable device capable of wireless communication.

In some embodiments, an interactive game room device, wherein the wireless reader and display are deployed as separate devices within a game room.

In some embodiments, the wireless reader and display are deployed within a single casing within a game room.

In some embodiments, the wireless reader and display are both deployed on a pole within a game room.

In some embodiments, the wireless sensor is a radio frequency identification sensor.

In some embodiments, the display is a touchscreen display and inputs received by the touch screen display are receivable by the game logic.

In some embodiments, the game logic is processed by the processor.

In some embodiments the communication port is further coupled to additional interactive game room devices within a single game room.

In some embodiments, the game logic is processed by a processor in an additional interactive game room device.

In some embodiments, the game logic is configured to initialize a game within the single game room utilizing the interactive game room device and additional interactive game room devices.

In some embodiments, a method of conducting a game with an interactive game room device includes executing a game mode via a processor located in an interactive game room device, receiving identification data via a wireless sensor located within the interactive game room device, wherein the identification data is associated with a player, determining a player association based on the received identification data, adjusting a game mode based on the determined player association, and directing a display of the interactive game room device to indicate the adjusted game state.

In some embodiments, an interactive game room device includes a wireless reader including a case, a processor, a wireless sensor, a plurality of illumination devices, and a communication port. The communication port is coupled to a game logic, and a touch-screen display, wherein the display is configured to interact with the game logic to display one or more current game states associated with the game logic on the display.

In some embodiments, the game logic is located within a memory associated with the interactive game display device.

In some embodiments, a wireless reader, includes a case, a processor, a wireless sensor, a plurality of illumination devices, and a communication port, wherein the communication port is coupled to a game logic.

In some embodiments, the case is comprised of plastic.

In some embodiments, the case includes two interlocking portions disposed along an interlocking plane.

In some embodiments, the first interlocking portion is included of clear plastic suitable for wireless signal transmission.

In some embodiments, the plurality of illumination devices are disposed within the case.

In some embodiments, the plurality of illumination devices are light-emitting diodes.

In some embodiments, the light-emitting diodes are configurable between a plurality of different colors.

In some embodiments, a selection of a color from the plurality of different colors is based on a current game state associated with the game logic.

In some embodiments, the wireless reader further includes a haptic motor.

In some embodiments, the engagement of the haptic motor is in response to a current game state associated with the game logic.

In some embodiments, the wireless sensor is a radio-frequency identification (RFID) sensor.

In some embodiments, the RFID sensor is configured to read data from a wearable device.

In some embodiments, the wearable device is a wristband.

In some embodiments, the RFID sensor is configured to capture data from the wristband upon placing the wristband against a portion of the game case.

In some embodiments, capturing data from the wristband triggers a communication via the communication port to the game logic.

In some embodiments, the communication is configured to elicit a change in the current game state.

In some embodiments, at least one of the plurality of illumination devices is directed to change a state in response to the change in the current game state.

In some embodiments, a haptic motor is engaged in response to the change in the current game state.

In some embodiments, the processor is associated with a microcontroller system.

In some embodiments, the communication port is an ethernet port.

In some embodiments, the communication port is a wireless networking device.

In some embodiments, the wireless networking device is a Wi-Fi device.

In some embodiments, the wireless networking device is a Bluetooth device.

In some embodiments, an interactive game display system includes a wireless reader including a case, a processor, a display driver, a wireless sensor, a plurality of illumination devices, and a communication port. The communication port is coupled to a game logic, and a display, including a display driver adapter, wherein the display driver is configured to interact with the display driver adapter to communicate display information to the display, and the display information is configured to display one or more current game states associated with the game logic.

In some embodiments, the one or more current game states is associated with a color assigned to a particular player.

In some embodiments, the display information and the plurality of illumination devices are configured to display a similar color assigned to the particular player.

In some embodiments, a player can interact with the wireless sensor with a wearable device.

In some embodiments, the proximity of the wireless reader in relation to the display allow for installation of the display at a first height, and the installation of the wireless reader at a second height.

In some embodiments, the first height is greater than the second height.

In some embodiments, the first height is at an eye level.

In some embodiments, the eye level is determined by the average height of the players playing the game.

In some embodiments, the first height can be adjusted based on the average height of the incoming players.

In some embodiments, the display information is configured to display a player's name that is required to interact with the wireless reader.

In some embodiments, the selection of the player's name is based on a current game state associated with the game logic.

In some embodiments, the display is a touch-screen display.

In some embodiments, the wireless reader is in wireless communication with a plurality of additional wireless readers.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a wireless reader in accordance with various embodiments of the disclosure;

FIG. 2 is a processor and wireless sensor of a wireless reader in accordance with various embodiments of the disclosure;

FIG. 3 is an interactive game room device mounted on a wall in accordance with various embodiments of the disclosure; and

FIG. 4 is a single-piece interactive game room device for mounting on a wall in accordance with various embodiments of the disclosure;

FIG. 5 is a conceptual illustration of a plurality of players engaging in a game with multiple interactive game room devices in accordance with various embodiments of the disclosure;

FIG. 6 is an exemplary game room with an interactive game room device mounted on a pole and a single-piece interactive game device in accordance with various embodiments of the disclosure;

FIG. 7 is a conceptual block diagram of a device suitable for configuration with a game logic, in accordance with various embodiments of the disclosure;

FIG. 8 is a flowchart depicting a process for executing a game on an interactive game room device;

FIG. 9 is a flowchart depicting a process for utilizing identification data within a game utilizing an interactive game room device; and

FIG. 10 is a flowchart depicting a process for restricting access to a game room utilizing an interactive game room device.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide an interactive game room device that can be utilized within an interactive game. By using the wireless reader, an interaction can occur within the game and be displayed on the display. This interaction can allow for changes in game states within a logic, such as, but not limited to, a game logic. The interactive game room devices can be disposed in an interactive gaming area for use in one or more games by various players.

The use of a wireless sensor, such as, but not limited to, an RFID reader in an active gaming situation can benefit the overall gaming experience by facilitating the ability to track players within a gaming space. Without this ability, it may be possible for players to cheat during gameplay, which reduces the overall level of enjoyment, especially in team competition games. In this way, a game logic or administrator could recognize just how fast it takes each player to get across a playfield, game room, or respond to one or more prompts. It could be known that a first player took ten seconds, a second player took nine seconds, a third player took twenty seconds, etc. In certain embodiments, data could be received for each event, i.e., level, and then average your times across all the levels. This data could be used to sort by player age, gender, by location, by time of day, etc.

Subsequently, to have individualized wearable devices, such as RFID readers mapped to each person's name and profile, certain embodiments allow for an onboarding system. In various embodiments, the system would require a player to input a player's data, such as their name into a computer, and during a process of wearable device assignment, the system would assign a wearable device, such as a wristband, to that name and then hand it to the player. This could then do this for each player per game. Various interactive games now can use wristbands to collect a variety of data on our players' performance in the games, which can be transferred or registered via the wireless readers.

The interactive game room device suitable for use in various interactive games can be an incredibly powerful multi-functional gaming combination. The interactive game room device allows us to pair the display above with the wireless sensor/transceiver below. This allows a number of unique game-related features. First and foremost, the interactive game room device can be used as an authentication mechanism to check players into games and to group them onto teams. For example, the display can show an interface depicting ‘add player to team’ and then players can tap their wristband on the associated RFID reader underneath. An icon for the player may then show up on the screen, and the player can drag and drop themselves in our user interface onto a team, Players that are checked into the system can also then select which games they want to play from the interface. If players are not authenticated with an RFID wristband or other wireless sensor, (e.g., in the case that they have not paid to participate, if the time of their experience is over, or if they are in the wrong gaming area), the visual interface on the interactive game room device can send them such messages about their permissions to play.

During game play, the interactive game room device can be used to show the specific name of one of a number of individuals making up a group of players in the game. For example, the game can require players to go and log into specific interactive game room devices, based on which one is showing their player name, To log in, players can tap on the associated wireless sensor underneath the display, which can require them to physically stand in front of the interactive game room device. Thus, game options can be displayed on the screen, which may be competitive or cooperative, but with certainty of which player is standing in front of which screen and operating that unique interactive game room device. If desired, frequent taps may be required on the wireless sensor to ensure that it is the same player (associated with the RED wristband) who is continuing to operate that screen. The games may require players to switch which interactive game room device is being used during the game itself.

Another use case of the interactive game room device is that when the associated wireless sensor is triggered, we can show a corresponding effect (such as an explosion) on the display of the interactive game room device. The ability to show messages on the screen can allow us to show feedback, such as “CORRECT” or “INCORRECT” for games in which the player is supposed to tap their wristband or other wearable device for a “Yes” or “No” answer. In certain types of games, the interactive game room device can allow players to play a game in which an image is displayed, (e.g., a piece of fruit such as an orange, apple or banana), and then we have instruction to the players to “acquire” the fruit and “bring it” to another reader, which is done by the player tapping their wristband or wearable device to the associated wireless sensor of the interactive game room device, and then walking to another area of the game room, and “depositing” the “fruit” that they have “acquired” by tapping on another wireless sensor of a different interactive game room device.

In further embodiments, another game may require players to compete by tapping their wearable devices, such as RFID wristbands, as fast as possible to avoid being the “last one remaining” with the displays of the interactive game room devices being used as the visual signal for when the players are allowed to tap. Given that certain wearable devices can be configured to change colors, players can be keyed as green or red where green means you can tap and red might be an immediate “knocked out.” In another example game, there are six playing cards displayed on a wall projection screen, which then quickly turn over, one of which is revealed to be a different card. Those 6 cards are then jumbled up, and “fan out” one card per interactive game room device around the room. Each player then needs to walk around and “vote” by tapping their wireless device on the associated wireless sensor of the interactive game room device that is configured to display each card.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

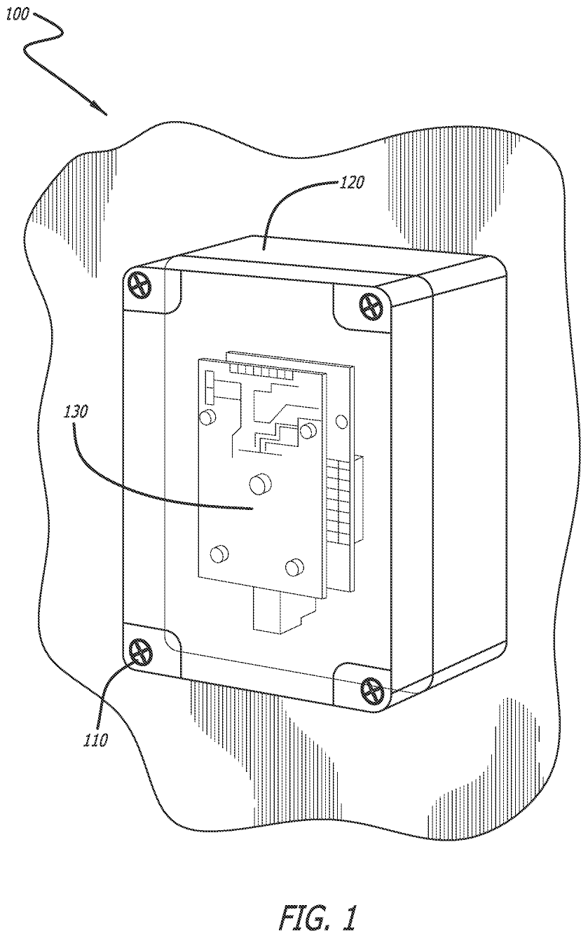

Referring to FIG. 1, a wireless reader 100 in accordance with various embodiments of the disclosure is shown. In many embodiments, the wireless reader 100 can be disposed within a case with a first front portion 110 and a second back portion 120. In more embodiments, the wireless reader 100 can comprise a processor 130 on a processing board which can execute various logics, such as a game logic, to control the various components of the wireless reader 100. In some embodiments, the wireless reader 100 can have a first portion 110 that is clear or otherwise made of a material that can facilitate improved wireless signal transmission with a wireless sensor and other wireless devices, such as a wearable device. In certain embodiments, the first front portion 110 can be printed or produced with an image, symbol, or target to aid users in accurately interacting with the reader.

In some embodiments, the wireless reader 100 can also comprise a haptic motor. In further embodiments, the one or more haptic motors can be engaged or disengaged at various levels in response to a change in game state initiated by a logic such as, but not limited to, a game logic. In various embodiments, the haptic motor can be disposed against the wireless reader case portions such that the generated vibrations are transferred efficiently to the user/game player. In additional embodiments, a plurality of wireless sensors can be deployed in a compact fashion, which can be placed with any type of suitable case for deployment. In still more embodiments, the wireless reader 100 can be configured with various communication ports, such as, but not limited to, ethernet jacks.

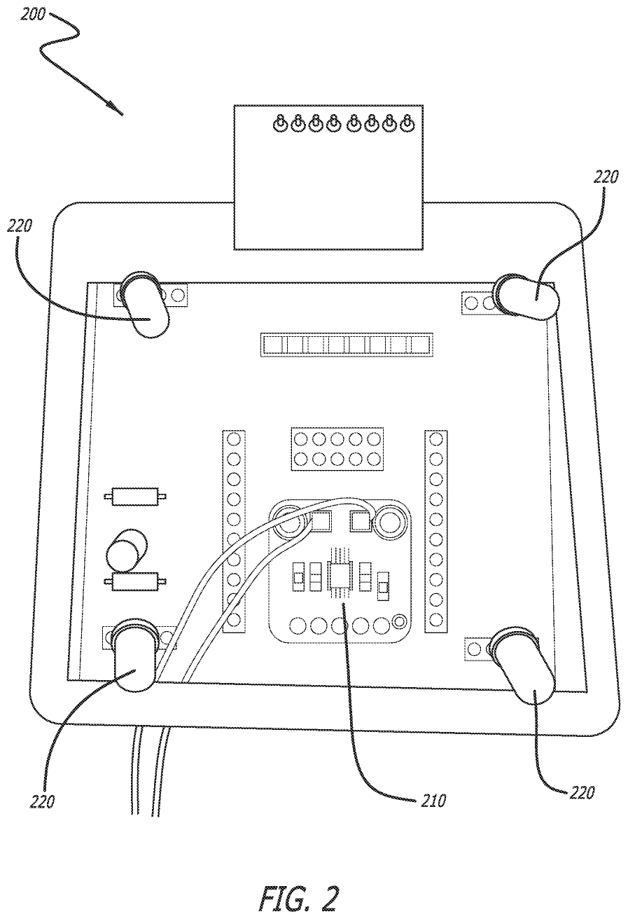

Although a specific embodiment for a wireless reader suitable for carrying out the various steps, processes, methods, and operations described herein is discussed with respect to FIG. 1, any of a variety of systems and/or processes may be utilized in accordance with embodiments of the disclosure. For example, the wireless reader 100 can be disposed within a case with multiple parts, or within a case that is composed of a single portion. The elements depicted in FIG. 1 may also be interchangeable with other elements of FIGS. 2-10 as required to realize a particularly desired embodiment.

Referring to FIG. 2, a processor 210 and wireless sensor 200 of a wireless reader in accordance with various embodiments of the disclosure is shown. In many embodiments, the wireless reader can include a wireless sensor 200 that can accept and process wireless signals. In more embodiments, the wireless sensor 200 can include a plurality of illumination devices 220 which can be engaged or change color in response to a change in game state initiated by a logic such as, but not limited to, a game logic. In various embodiments, the wireless sensor 200 can be disposed within a case for deployment in a gaming environment.

In some embodiments, the wireless sensor 200 can be a wireless transceiver, such as, but not limited to, a radio frequency identification (RFID) sensor. In a number of embodiments, the wireless sensor 200 can be part of an interactive game room device and be communicatively coupled with a display and at least one logic, such as a game logic. The game logic can reside within a memory which can be disposed within the wireless sensor 200 in certain embodiments. In more embodiments, the game logic can reside within a separate device and interact with the wireless reader and interactive game room device via the communication port. In some embodiments, the communication port can also be utilized to communicate with the display. In additional embodiments, the wireless sensor 200 can additionally include a processor and memory which can comprise and execute a game logic and/or a display driver to interact with a display within the interactive game room device.

Although a specific embodiment for a processor and wireless sensor of a wireless reader suitable for carrying out the various steps, processes, methods, and operations described herein is discussed with respect to FIG. 2, any of a variety of systems and/or processes may be utilized in accordance with embodiments of the disclosure. For example, the various components may be combined within a single unit or may be comprised of various individual components in electrical communication with each other. The elements depicted in FIG. 2 may also be interchangeable with other elements of FIGS. 1 and 3-10 as required to realize a particularly desired embodiment.

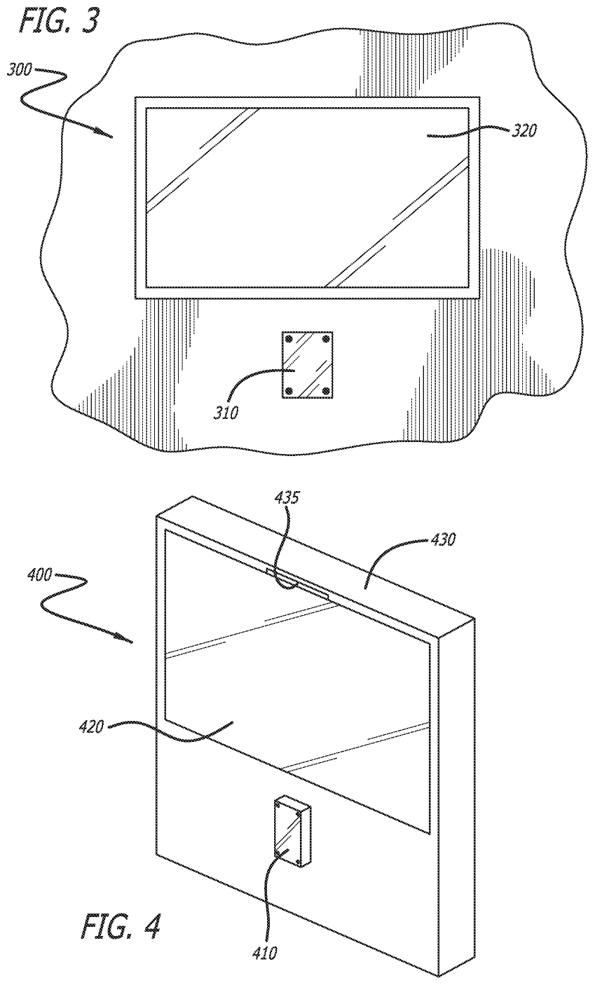

Referring to FIG. 3, an interactive game room device 300 mounted on a wall in accordance with various embodiments of the disclosure is shown. As described above, the interactive game room device 300 can be deployed in a variety of ways, including as separate devices in a game room as depicted in the embodiment shown in FIG. 3. In some embodiments, the interactive game room device 300 can comprise a wireless reader 310 and a display 320.

In additional embodiments, the display 320 can be at a first height within the game room and the wireless reader 310 is at a second height. In many embodiments, the first height can be higher than the second height, such that the wireless reader 310 is below the display 320. In still more embodiments, a game room can be deployed with a plurality of interactive game room devices 300 such that each display 320 is at the same height and each wireless reader 310 is at the same height across the room.

Although a specific embodiment for an interactive game room device 300 mounted on a wall suitable for carrying out the various steps, processes, methods, and operations described herein is discussed with respect to FIG. 3, any of a variety of systems and/or processes may be utilized in accordance with embodiments of the disclosure. For example, the interactive game room device can be deployed with a plurality of illumination devices which can be disposed in various positions as desired. The elements depicted in FIG. 3 may also be interchangeable with other elements of FIGS. 1-2 and 4-10 as required to realize a particularly desired embodiment.

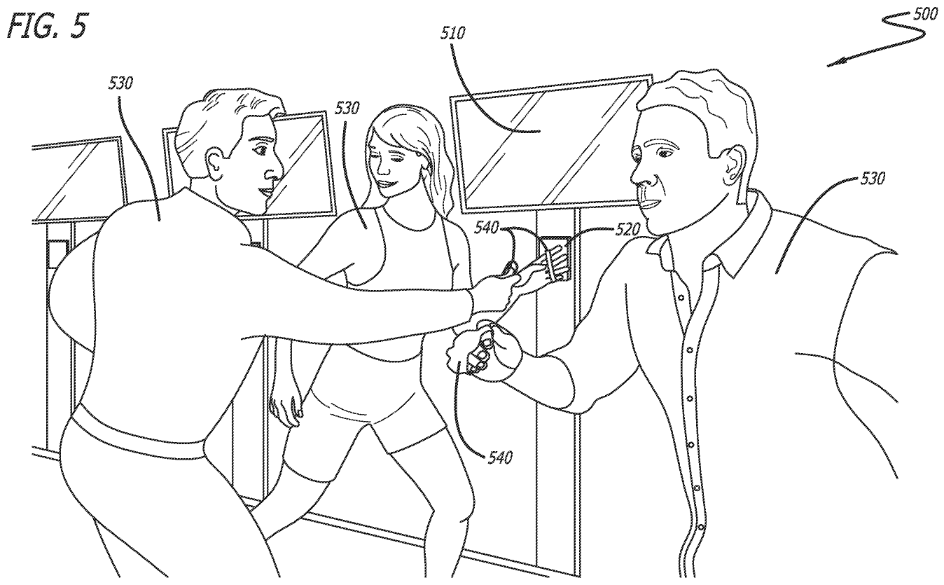

Referring to FIG. 4, a single-piece interactive game room device 400 for mounting on a wall in accordance with various embodiments of the disclosure is shown. In certain deployments, it may be desirable to have a single interactive game room device unit (or “single-piece”) to mount on a wall, pole, or other location. For example, certain games may be more advantageous to be played with the display or wireless reader at a different height. In additional examples, the user of a single-piece interactive game room device may negate the need to properly install the display 420 and wireless reader 410 at the correct height from each other. In more embodiments, the mounting surface may not be suitable for an embedded or otherwise loose connection between the display 420 and wireless reader 410. This can occur when drilling in a wall to connect the display to the wireless reader or to another processing unit is not feasible.

In still more embodiments, the heights of the display 420 and wireless reader 410 may be dynamically raised and/or lowered depending on various factors. For example, the single-piece interactive game room device 400 can be deployed on a moveable rail or other fastener that can allow it to be positioned higher or lower, such as when adults play a game in a game room versus younger kids. This can keep the game view on the display 420 and action area of the wireless reader 410 within a similar zone relative to the players playing the game. In certain games, this might be customized on a per-player basis based on that player's known characteristics such as, but not limited to, height or abilities (e.g., allowing a person in a wheelchair to play a game with non-wheelchair bound players, etc.).

The single-piece interactive game room device 400 can also include a lid 430 which can allow for easy access to the internal components. In various embodiments, the lid 430 may be accessible via a notch 435 that can provide room for fingers to grab the lid 430 to open it. Although the embodiment depicted in FIG. 4 shows the single-piece interactive game room device 400 with a specific thickness, it should be understood by those skilled in the art that any thickness can be provided depending on the components utilized within. Additionally, other interactive elements can be present including, but not limited to, speakers, cameras, headsets, motion controls, body tracking devices, illumination devices, haptic motors, etc.

Although a specific embodiment for a single-piece interactive game room device 400 for mounting on a wall suitable for carrying out the various steps, processes, methods, and operations described herein is discussed with respect to FIG. 4, any of a variety of systems and/or processes may be utilized in accordance with embodiments of the disclosure. For example, the configuration of various components, such as the display 420 and wireless reader 410 can vary based on the desired application such that additional or a reduced number of devices needed for deployment. The elements depicted in FIG. 4 may also be interchangeable with other elements of FIGS. 1-3 and 5-10 as required to realize a particularly desired embodiment.

Referring to FIG. 5, a conceptual illustration of a plurality of players 530 engaging in a game with multiple interactive game room devices 500 is shown. In various embodiments, the interactive game room devices comprise a combination display 510 and wireless reader device 520 being utilized during gameplay. In the embodiment depicted in FIG. 5, a plurality of players 530 are playing an interactive game with the combination display 510 and wireless reader device 520. Specifically, each player 530 is associated with a wearable device 540, which can be, but is not limited to, a wireless signal generator, such as a RFID wristband/bracelet/charm which can interact with the wireless reader.

In more embodiments, the display 510 can be configured to indicate one or more game modes or game states. These game states can have game state data associated with it and can be modified based on a change in the game state data triggered by the interaction between the wearable devices 540 and the wireless reader device 520. The game state can be determined by a game logic in communication with the plurality of interactive game room devices 500. In fact, a plurality of combination interactive game room devices can be connected communicatively through a wired or wireless communication connection, such as a wireless signal protocol, ethernet cables, etc.

Although a specific embodiment for a combination display and wireless reader device 520 being utilized during gameplay suitable for carrying out the various steps, processes, methods, and operations described herein is discussed with respect to FIG. 5, any of a variety of systems and/or processes may be utilized in accordance with embodiments of the disclosure. For example, the interactive game room devices 500 can be deployed in a variety of interactive gaming environments, such as game rooms, in any type of arrangement suitable for gameplay. The elements depicted in FIG. 5 may also be interchangeable with other elements of FIGS. 1-4 and 10 as required to realize a particularly desired embodiment.

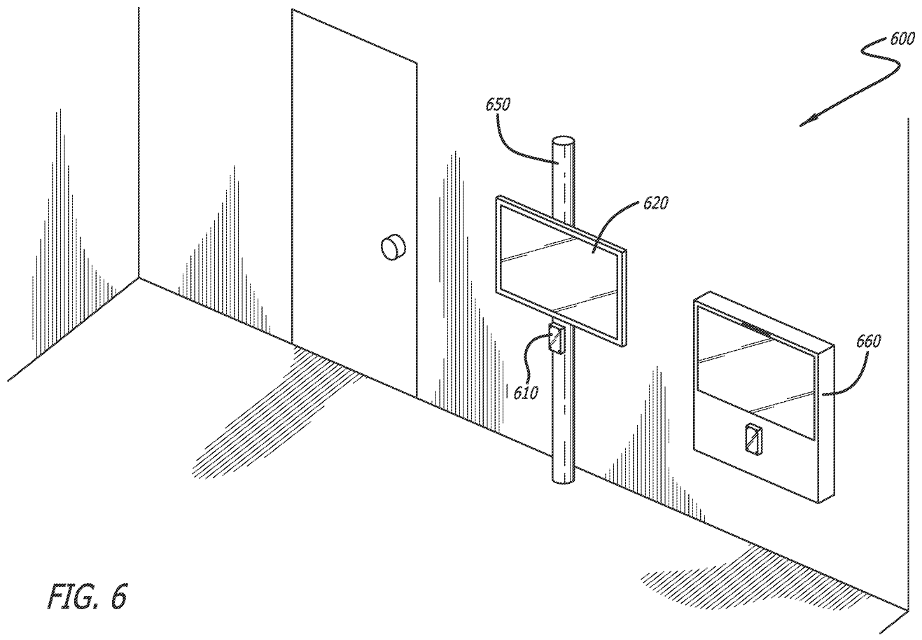

Referring to FIG. 6, an exemplary game room 600 with an interactive game room device mounted on a pole 650 and a single-piece interactive game room device 660 in accordance with various embodiments of the disclosure is shown. As previously discussed, the specific deployment of various interactive game room devices can vary based on the type of game room desired, and/or the environment provided. In many embodiments, the interactive game room device can be comprised of a display 620 mounted on a pole or other fixed surface directly above a wireless reader 610. In various embodiments, the display 620 can be disposed at eye level. The wireless reader 610 can be disposed directly under the display 620 at a fixed distance, and can be often directly under the middle of the display 620. The combination display and wireless reader device can also be placed along a wall of a game room such that a doorway can be disposed between other single-piece interactive game room devices 660.

In the embodiment depicted in FIG. 6, the game room 600 is configured with a single-piece interactive game room device 660 and an interactive game room device comprising a display 620 and wireless reader 610 mounted to a pole 650. In some embodiments, the pole 650 may be installed within the game room 600 but may also be present in the game room 600 prior to deployment, for example, as a structural element. In additional embodiments, the game room 600 can be configured with a variety of interactive game room devices, which can be deployed on each of the walls of the game room 600. As those skilled in the art will recognize, the specific configuration of interactive game room devices can vary based on the desired game room, game, or other requirement associated with each specific game room.

Although a specific embodiment for an exemplary game room with an interactive game room device mounted on a pole and a single-piece interactive game device suitable for carrying out the various steps, processes, methods, and operations described herein is discussed with respect to FIG. 6, any of a variety of systems and/or processes may be utilized in accordance with embodiments of the disclosure. For example, the interactive game room devices can be placed such that each combination is roughly equidistant from the center of an interactive game room. The elements depicted in FIG. 6 may also be interchangeable with other elements of FIGS. 1-5 and 7-10 as required to realize a particularly desired embodiment.

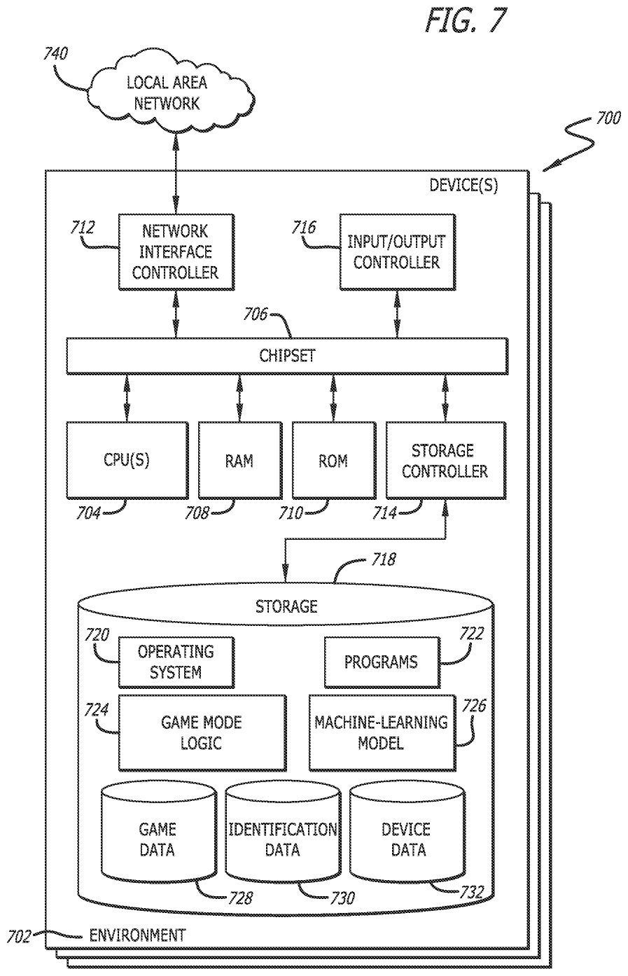

Referring to FIG. 7, a conceptual block diagram of a device 700 suitable for configuration with a game logic 724, in accordance with various embodiments of the disclosure is shown. The embodiment of the conceptual block diagram depicted in FIG. 7 can illustrate a conventional game room device, server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 7 can also illustrate an interactive game room device, wireless sensor device, or other game room deployed computing device in accordance with various embodiments of the disclosure. The device 700 may, in many non-limiting examples, correspond to physical devices or to virtual resources described herein.

In many embodiments, the device 700 may include an environment 702 such as a baseboard or “motherboard,” in physical embodiments that can be configured as a printed circuit board with a multitude of components or devices connected by way of a system bus or other electrical communication paths. Conceptually, in virtualized embodiments, the environment 702 may be a virtual environment that encompasses and executes the remaining components and resources of the device 700. In more embodiments, one or more processors 704, such as, but not limited to, central processing units (“CPUs”) can be configured to operate in conjunction with a chipset 706. The processor(s) 704 can be standard programmable CPUs that perform arithmetic and logical operations necessary for the operation of the device 700.

In a number of embodiments, the processor(s) 704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 706 may provide an interface between the processor(s) 704 and the remainder of the components and devices within the environment 702. The chipset 706 can provide an interface to a random-access memory (“RAM”) 708, which can be used as the main memory in the device 700 in some embodiments. The chipset 706 can further be configured to provide an interface to a computer-readable storage medium such as a read-only memory (“ROM”) 710 or non-volatile RAM (“NVRAM”) for storing basic routines that can help with various tasks such as, but not limited to, starting up the device 700 and/or transferring information between the various components and devices. The ROM 710 or NVRAM can also store other application components necessary for the operation of the device 700 in accordance with various embodiments described herein.

Additional embodiments of the device 700 can be configured to operate in a networked environment using logical connections to remote computing devices and computer systems through a network, such as the network 740. The chipset 706 can include functionality for providing network connectivity through a network interface card (“NIC”) 712, which may comprise a gigabit Ethernet adapter or similar component. The NIC 712 can be capable of connecting the device 700 to other devices over the network 740. It is contemplated that multiple NICs 712 may be present in the device 700, connecting the device to other types of networks and remote systems.

In further embodiments, the device 700 can be connected to a storage 718 that provides non-volatile storage for data accessible by the device 700. The storage 718 can, for instance, store an operating system 720, applications 722, game data 728, identification data 730, and device data 732 which are described in greater detail below. The storage 718 can be connected to the environment 702 through a storage controller 714 connected to the chipset 706. In certain embodiments, the storage 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 700 can store data within the storage 718 by transforming the physical state of the physical storage units to reflect the information being stored. The specific transformation of physical state can depend on various factors. Examples of such factors can include, but are not limited to, the technology used to implement the physical storage units, whether the storage 718 is characterized as primary or secondary storage, and the like.

In many more embodiments, the device 700 can store information within the storage 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 700 can further read or access information from the storage 718 by detecting the physical states or characteristics of one or more particular locations within the physical storage units.

In addition to the storage 718 described above, the device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 700. In some examples, the operations performed by a cloud computing network, and or any components included therein, may be supported by one or more devices similar to device 700. Stated otherwise, some or all of the operations performed by the cloud computing network, and or any components included therein, may be performed by one or more devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 718 can store an operating system 720 utilized to control the operation of the device 700. According to one embodiment, the operating system comprises the LINUX operating system. According to another embodiment, the operating system comprises the WINDOWS®SERVER operating system from MICROSOFT Corporation of Redmond, Washington. According to further embodiments, the operating system can comprise the UNIX operating system or one of its variants. It should be appreciated that other operating systems can also be utilized. The storage 718 can store other system or application programs and data utilized by the device 700.

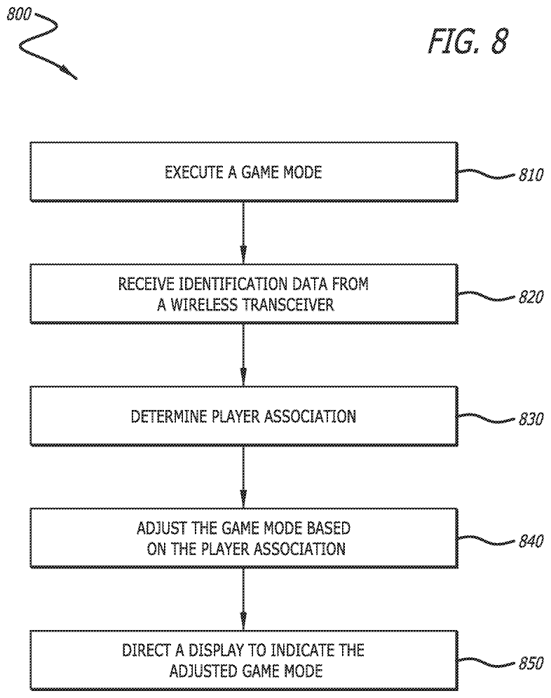

In many additional embodiments, the storage 718 or other computer-readable storage media is encoded with computer-executable instructions which, when loaded into the device 700, may transform it from a general-purpose computing system into a special-purpose computer capable of implementing the embodiments described herein. These computer-executable instructions may be stored as application 722 and transform the device 700 by specifying how the processor(s) 704 can transition between states, as described above. In some embodiments, the device 700 has access to computer-readable storage media storing computer-executable instructions which, when executed by the device 700, perform the various processes described above with regard to FIGS. 1-6 and below in regard to FIGS. 8-10. In certain embodiments, the device 700 can also include computer-readable storage media having instructions stored thereupon for performing any of the other computer-implemented operations described herein.

In many further embodiments, the device 700 may include a game logic 724. The game logic 724 can be configured to perform one or more of the various steps, processes, operations, and/or other methods that are described above. Often, the game logic 724 can be a set of instructions stored within a non-volatile memory that, when executed by the processor(s)/controller(s) 704 can carry out these steps, etc. In some embodiments, the game logic 724 may be a client application that resides on a network-connected device, such as, but not limited to, an interactive game room device, a server, switch, personal or mobile computing device in a single or distributed arrangement. The game logic 724 may receive game data from one or more other devices. The game logic 724 can determine the device parameters associated with the plurality of interactive game room devices within each game room. The game logic 724 may execute a game with a plurality of different players, and update various game modes based on one or more interactions within the game room.

In yet still more embodiments, the device 700 may include game data 728 which may be comprised of various elements essential for defining and managing the gameplay experience. Firstly, game data 728 may include the rules and objectives that outline how the game is to be played, including the specific tasks or challenges players must complete to progress. It can also encompass parameters that determine the game's structure, such as difficulty levels, time limits, and scoring metrics. Additionally, game data 728 may contain detailed information about the game environment, including maps, layouts, and interactive elements that players will encounter.

In some embodiments, game data 728 may also incorporate predefined events and triggers within the plurality of interactive game room devices, which can dictate how the game responds to player actions. For instance, certain player achievements might unlock new levels or activate special features. Game data can also include multimedia components such as graphics, sounds, and animations that enhance the immersive experience, as well as narrative elements that provide context and storyline progression. Moreover, game data 728 can involve configuration settings for the interactive game room devices, ensuring they operate in sync with the game's requirements. This may include the calibration of sensors, displays, and other interactive elements to create a cohesive and responsive environment. In multiplayer scenarios, game data 728 can include coordination protocols for team dynamics, roles, and cooperative tasks, ensuring a balanced and collaborative gameplay experience.

In additional embodiments, the device 700 can also include identification data 730. In a system that utilizes identification data 730 within an interactive game room, this data can be comprised of several components to ensure comprehensive identification and personalized gameplay experiences. Firstly, it may include a unique identifier (UID) assigned to each player's RFID device, such as a bracelet. This UID can be utilized for distinguishing individual players within the game system. Additionally, identification data 730 can encompass user-specific information, including the player's name, profile details, and gaming preferences. This data can also store a player's gaming history, capturing their achievements, skill levels, and any unlocked content or special features relevant to their gameplay. In some embodiments, identification data 730 can incorporate access credentials, determining what areas of the game room(s)/facilities or features the player is authorized to access. In transactional systems, it may include account-related information like balance and recent transactions, or event logs which are another component capable of recording timestamps of player interactions, checkpoints visited, and actions taken during gameplay, which help track and personalize the gaming experience in real-time. In certain embodiments, health and safety information might also be part of the identification data, especially in scenarios where player wellbeing is monitored.

In more embodiments, the device 700 can include device data 732 which may comprise various elements for ensuring the proper functioning and integration of the hardware components with the gameplay experience. In some embodiments, device data can include identification and configuration details for each interactive device in the game room, such as sensors, displays, illumination devices, lasers, projection screens, and other physical devices. This information can ensure that each device is correctly recognized and configured within the system, enabling seamless interaction and communication.

In additional embodiments, device data 732 can encompass the operational status and health metrics of each device, including power levels, connectivity status, and any potential maintenance issues. This can allow the system or a facilities administrator to monitor the performance and reliability of the devices, ensuring they are functioning optimally and addressing any problems promptly. Device data 732 can also include calibration settings, ensuring that sensors and interactive elements are precisely tuned for accurate detection and response to player actions. In further embodiments, device data 732 may comprise real-time interaction logs, capturing how and when each device is used during gameplay. This can include data on player interactions, such as touches, movements, and other inputs detected by the devices, which are essential for creating a responsive and immersive experience. In certain embodiments, the device data 732 can be utilized to determine one or more games or game parameters based on the current makeup of the available devices. For example, if a certain device is not functioning correctly, the device data 732 associated with that device can be utilized to adjust a parameter of the game, such as requiring fewer inputs into the device to score, etc.

In still further embodiments, the device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can be configured to provide output to a display, such as a computer monitor, a flat panel display, a digital projector, a printer, or other type of output device. Those skilled in the art will recognize that the device 700 might not include all of the components shown in FIG. 7 and can include other components that are not explicitly shown in FIG. 7 or might utilize an architecture completely different than that shown in FIG. 7.

As described above, the device 700 may support a virtualization layer, such as one or more virtual resources executing on the device 700. In some examples, the virtualization layer may be supported by a hypervisor that provides one or more virtual machines running on the device 700 to perform functions described herein. The virtualization layer may generally support a virtual resource that performs at least a portion of the techniques described herein.

Finally, in numerous additional embodiments, data may be processed into a format usable by a machine-learning model 726 (e.g., feature vectors), and or other pre-processing techniques. The machine-learning (“ML”) model 726 may be any type of ML model, such as supervised models, reinforcement models, and/or unsupervised models. The ML model 726 may include one or more of linear regression models, logistic regression models, decision trees, Naïve Bayes models, neural networks, k-means cluster models, random forest models, and/or other types of ML models 726.

The ML model(s) 726 can be configured to generate inferences to make predictions or draw conclusions from data. An inference can be considered the output of a process of applying a model to new data. This can occur by learning from at least the game data 728, the identification data 730, and the device data 732 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 726 may be generated by human/administrator verifications or may compare predicted outcomes with actual outcomes.

In certain embodiments, ML models 726 could analyze the identification data 730 from players, learning their preferences, behavior patterns, and skill levels over time. By processing this data, the ML models 726 can personalize game modes, dynamically adjusting difficulty levels and content to match the player's abilities and interests, thereby providing a tailored gaming experience that evolves as the player progresses. In further embodiments, ML models 726 could be used to predict player actions and preferences, enabling the game system to proactively adapt the environment and challenges. For example, if a model identifies that a player frequently struggles with a particular type of puzzle, it can adjust future puzzles to be more accessible or provide additional hints, enhancing player engagement and satisfaction. These models can also optimize game flow and pacing, ensuring that players remain challenged but not frustrated, by balancing the introduction of new tasks and rewards based on their progress and performance.

In multiplayer scenarios, ML models 726 can be configured to analyze team dynamics and individual contributions, helping to balance teams and assign roles that maximize cooperation and effectiveness. They can identify patterns in how players interact and collaborate, using this information to create more cohesive and enjoyable team experiences. Additionally, machine learning models can monitor device data 732, predicting maintenance needs and preventing downtime by identifying patterns that indicate potential hardware failures before they occur. ML models 726 may also enhance security by detecting unusual patterns of behavior that may indicate unauthorized access or cheating, thereby ensuring a fair and secure gaming environment.

Although a specific embodiment for a conceptual block diagram of a device suitable for configuration with a game logic suitable for carrying out the various steps, processes, methods, and operations described herein is discussed with respect to FIG. 7, any of a variety of systems and/or processes may be utilized in accordance with embodiments of the disclosure. For example, the device 700 may be in a virtual environment such as a cloud-based network suite, or it may be distributed across a variety of game devices or game room systems. The elements depicted in FIG. 7 may also be interchangeable with other elements of FIGS. 1-6 and 8-10 as required to realize a particularly desired embodiment.

Referring to FIG. 8, a flowchart depicting a process 800 for executing a game on an interactive game room device is shown. In many embodiments, the process 800 can execute a game mode (block 810). Operating a game mode within an interactive game room can involve several elements to ensure a seamless and engaging experience for players. Firstly, the game mode can be clearly defined, including its objectives, rules, and any special conditions or win scenarios. This can range from timed challenges to puzzle-solving or competitive team-based activities. In some embodiments, these elements can be shown on a display of the interactive game room devices. In certain embodiments, the elements can be displayed on a large central screen that is visible throughout the room. Additionally, the game room environment can be configured to be immersive, with themed decor, sound effects, and lighting to enhance the gaming experience.

In a number of embodiments, the process 800 can receive identification data from a wireless transceiver (block 820). In various embodiments, the wireless transceiver can be a radio frequency identification (RFID) device, such as, but not limited to, a wristband. This identification data can be read in some embodiments by a wireless sensor within the interactive game room devices.

In certain embodiments, a player equipped with an RFID device enters an interactive game room. The RFID device, such as a wristband, contains unique identification data specific to that player. In some embodiments, as the player interacts with various elements within the game room, wireless sensors placed strategically around the environment continuously read the identification data from the RFID device. These sensors are designed to detect the presence and movement of the RFID device, enabling the system to track the player's location and actions in real-time. However, in many embodiments, the tracking of a player occurs upon interaction of the RFID wristband or other personalized wireless transceiver with a wireless sensor of one or more interactive game room devices. In this way, the player can be tracked at different locations within the game room. As those skilled in the art will recognize, this can be utilized and integrated into various game play mechanics within a game mode.

This tracking capability can allow the game logic and associated game mode to personalize the gaming experience for each player. For instance, as the player approaches certain game elements or completes specific tasks, the system can trigger customized responses or unlock new game levels or elements based on the player's unique identification data. Additionally, the system can record the player's progress and achievements, which can be used to update leaderboards or provide feedback at the end of the session. Furthermore, the use of RFID technology enhances the security and management of the interactive game room. By associating each RFID device with a specific player, the system can ensure that only authorized participants can access certain areas or game features. This helps to maintain an organized and controlled gaming environment, reducing the risk of unauthorized access or cheating.

In more embodiments, the process 800 can determine a player association (block 830). Game logic can effectively utilize identification data from wireless transceivers, such as RFID wristbands, to manage player associations within an interactive game room. When a player enters the game room or just prior, such as when registering at a game room business, they can receive an RFID wristband linked to a unique profile within a game system database. In some embodiments, the player can scan their wristband at a registration kiosk, allowing the game system to read the identification data and retrieve the player's profile, which may include, but is not limited to, their name, game preferences, progress history, current score(s), etc. As the player moves through the game room, wireless sensors continuously read the identification data from the wristband, enabling the game logic to track the player's location and interactions in real-time.

In additional embodiments, the process 800 can adjust the game mode based on the player association (block 840). The identification data can allow the game logic to personalize the player's experience by directing them toward tasks that match their preferences and adjusting the difficulty level based on their past performance. In some embodiments, the process 800 can record the player's achievements and update their profile, ensuring accurate progress tracking and appropriate recognition for accomplishments. Additionally, the identification data can help enforce security measures by verifying player access to restricted areas, or triggering of incorrect elements within a game, as well as preventing unauthorized entry to another game room, thereby maintaining a safe and organized gaming environment. In multiplayer scenarios, the process 800 can form teams or assign roles based on identification data, facilitating communication and coordination among team members.

In further embodiments, the process 800 can direct a display to indicate the adjusted game mode (block 850). In various embodiments, the process 800 can utilize the identification data from RFID wristbands to dynamically adjust and direct displays in an interactive game room device to indicate changes in a game mode based on player actions. As players move through the game room and interact with various elements, wireless sensors, such as those in interactive game room devices, can continuously read the RFID data, providing real-time updates on player location and activities. This information allows a game logic to determine the player's progress, preferences, and performance.

In certain embodiments, when the system detects that a player has reached a specific milestone or interacted with a particular game element, it can trigger an adjusted game mode tailored to that player. For example, if a player completes a series of puzzle challenges, the game logic might switch the display to a new game mode featuring a timed challenge, etc. The display can also show personalized messages, hints, or rewards based on the player's actions, creating a more immersive and responsive experience. Those skilled in the art will recognize that any of a variety of game mode changes can occur based on the desired game play mechanics specific to each game currently running.

Moreover, in multiplayer settings, some embodiments of the process 800 may adjust the display according to team dynamics or individual roles. For example, if a player is assigned a leadership role within a team, the display might highlight their objectives or provide strategic information to guide the team's efforts. By directing the display to reflect the adjusted game mode, the system ensures that players receive real-time feedback and tailored content that enhances their engagement and interaction within the game room. This seamless integration of player actions and dynamic display adjustments can improve overall game system performance by creating a more cohesive and enjoyable gaming experience that would not be possible by simple human or manual interactions.

Although a specific embodiment for a process for executing a game on an interactive game room device suitable for carrying out the various steps, processes, methods, and operations described herein is discussed with respect to FIG. 8, any of a variety of systems and/or processes may be utilized in accordance with embodiments of the disclosure. For example, the interactive game room devices may be one part of many elements within a game room, and the display of the interactive game room device can be directed to display elements based on sensor readings by other wireless sensors from different interactive game room devices. The elements depicted in FIG. 8 may also be interchangeable with other elements of FIGS. 1-7 and 9-10 as required to realize a particularly desired embodiment.

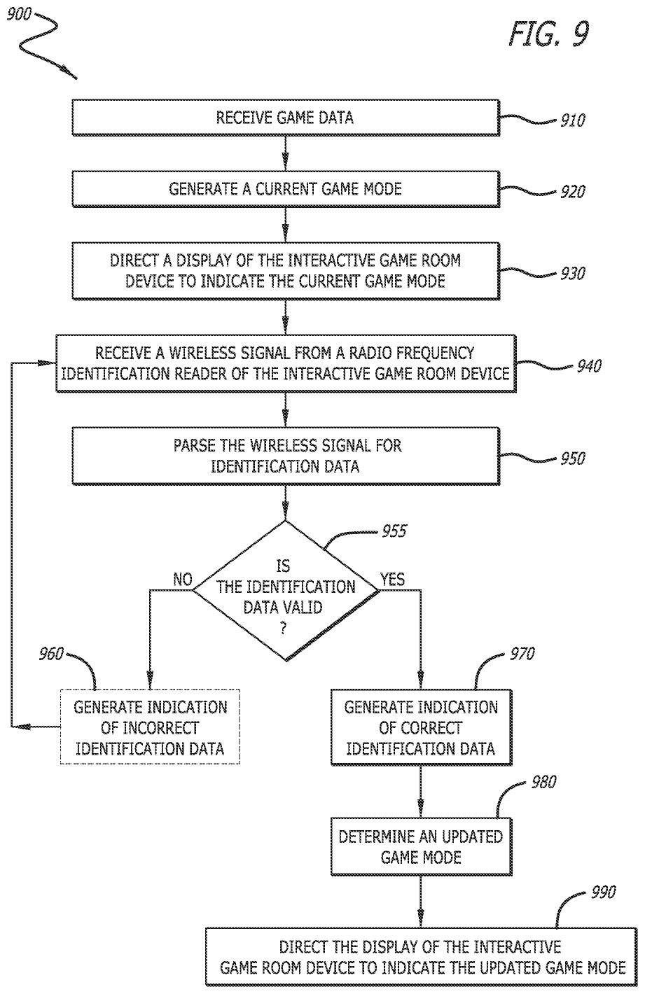

Referring to FIG. 9, a flowchart depicting a process 900 for utilizing identification data within a game utilizing an interactive game room device is shown. In many embodiments, the process 900 can receive game data (block 910). The game data may be related to a specific game to be operated within a game room. In certain embodiments, game data can encompass the rules, objectives, and various parameters that define the gameplay experience. Concurrently, the system can also receive identification data from wireless transceivers, such as RFID wristbands, worn by the players.

In a number of embodiments, the process 900 can generate a current game mode (block 920). Game data can be utilized for generating a game mode within an interactive game room, leveraging the capabilities of the room's devices to create an immersive and engaging experience. Initially, the game data, which includes the rules, objectives, and parameters specific to the game, can be input into the game room system, which can include a game logic. This data can define the framework within which the game operates, specifying how players interact with the environment and the goals they need to achieve.

In more embodiments, the process 900 can direct a display of the interactive game room device to indicate the current game mode (block 930). In an interactive game room, the display can play a pivotal role in communicating the current game mode to players, enhancing immersion and guiding their actions. Leveraging game data and identification information, the display can be dynamically updated to reflect the game mode in real-time. As the game begins, the display may be configured to show an introductory screen detailing the game's objectives, rules, and any specific instructions relevant to the initial game mode. This setup ensures players are immediately aware of the context and goals as they enter the interactive environment.

In various embodiments, the display can be directed to display the current game mode, showcasing real-time updates based on players' interactions and progress. For example, if the game mode shifts from a puzzle-solving challenge to a timed obstacle course, the display transitions accordingly, presenting a countdown timer, scoring metrics, and visual cues that emphasize the urgency and new objectives. In another example, the display may indicate which player should be standing in front of each of the available interactive game room devices. Additionally, the display can serve as a central point for providing real-time feedback and maintaining the game's narrative flow. When a player completes a task or reaches a milestone, the display celebrates their achievement with visual and auditory feedback, reinforcing their progress and motivating further engagement. If the game requires players to make choices or respond to events, the display can prompt them with interactive options, ensuring seamless interaction with the game occurring within the game room.

In additional embodiments, the process 900 can receive a wireless signal from a radio frequency identification reader of the interactive game room device (block 940). In certain embodiments, the wireless signal is from an RFID device, such as, but not limited to, an RFID bracelet. This can occur from a player who has placed an RFID bracelet next to the wireless sensor of an interactive game room device. In these embodiments, the wireless sensor can interact and receive data transmitted from the RFID bracelet or other wireless device and pass it to the game logic for further processing. However, as those skilled in the art will recognize, the wireless sensor may receive data from a number of wireless devices beyond an RFID device or transceiver.

In further embodiments, the process 900 can parse the wireless signal for identification data (block 950). For example, an RFID device, such as an RFID bracelet, can transmit a variety of data that can be configured for identifying and tracking individuals across different contexts. Primarily, it may transmit a unique identifier (UID), a specific number or code assigned to each device, allowing the system to distinguish between different devices and users. Additionally, the device can store and transmit user-specific information, such as names, membership numbers, or other identifying details, linking to a player's profile in a gaming scenario. This profile might include gaming history, preferences, and achievements. In some embodiments, the data may be processed directly within the interactive game room device, while other embodiments may transmit all or a portion of the data to a game logic located externally of the interactive game device. In yet more embodiments, the UID data may be linked to an external database to gather the remaining data associated with a player for further processing.

In still more embodiments, the process 900 can determine if the identification data is valid (block 955). Certain game modes may be configured to expect an interaction between a player (via their assigned wireless device, such as an RFID wristband) and a specific wireless sensor associated with an interactive game room device. For example, a game mode may indicate that certain players need move within the game room to an interactive game room device with a certain color (e.g., player 1 is supposed to check-in at the interactive game room device that is displaying their name). In these types of interactions, the game logic may be configured to detect and avoid cheating by players by verifying that the player interacting with the interactive game room device is the specific player indicated. In various embodiments, this determination can be made by gathering identification data from the wireless sensor of the interactive game room device. If each player has been assigned a unique wireless device, then a determination can be made if the identification data received matches the identification data expected at that time and/or at that location.

If it is determined that the identification data is not valid, certain embodiments of the process 900 can optionally generate an indication of incorrect identification data (block 960). The indications can vary depending on the specific game being played and the available elements/components in the game room. For example, an indication can be to display a specific color, text, or symbol on the display of the interactive game room device to indicate that the identification data received was not correct. Likewise, an audible noise, vibration from a haptic feedback device, and/or illumination of one or more light sources can also be configured to indicate similar events. This can allow players to try again, which provides a means for the process 900 to again receive a wireless signal from a wireless sensor of the interactive game room device (block 940).

However, if the process 900 determines that the identification is valid, then various embodiments can generate an indication of correct identification data (block 970). Similar to indicating an incorrect match, certain embodiments can display a specific color, text, or symbol on the display of the interactive game room device to indicate that the identification data received was not correct. Likewise, an audible noise, vibration from a haptic feedback device, and/or illumination of one or more light sources can also be configured to indicate the same. In some embodiments, no direct response may occur and may instead direct a signal to call for the next game mode or to update the game mode.

In yet further embodiments, the process 900 can determine an updated game mode (block 980). When a game determines that the identification data presented at a wireless sensor in an interactive game room device is correct, it can dynamically change the game mode to tailor the experience to the specific player. This could include moving the game along to the next game state. For example, if the game required players to move to an interactive game room device that is displaying their names within a given amount of time, the game mode updating could add points for that round and/or initiate the next round of the same game.

Moreover, the updated game mode could unlock special features or content exclusive to the identified player, such as new levels, characters, or power-ups, creating a sense of progression and reward. In a multiplayer setting, recognizing the player's data can prompt the game to assign specific roles or tasks that complement the team dynamics, ensuring a balanced and collaborative gameplay experience. The display in the game room would then update in real-time to reflect these changes, providing clear instructions and feedback to the player.

In still additional embodiments, the process 900 can direct the display of the interactive game room device to indicate the updated game mode (block 990). As discussed above, the updated game mode can be configured to move the game onto the next task which can be indicated via one or more displays within the game room, such as, but not limited to, the interactive game room device displays. Those skilled in the art will recognize that updating the game mode via a display can be done in a variety of ways such as changing color, adding or removing visual assets, or replacing one image for another, etc.

Although a specific embodiment for a process for utilizing identification data within a game utilizing an interactive game room device suitable for carrying out the various steps, processes, methods, and operations described herein is discussed with respect to FIG. 9, any of a variety of systems and/or processes may be utilized in accordance with embodiments of the disclosure. For example, the game mode updating can be done by a game logic that is located within an interactive game room device, or within a specialized game room device that is in communication with the plurality of interactive game room devices. The elements depicted in FIG. 9 may also be interchangeable with other elements of FIGS. 1-8 and 10 as required to realize a particularly desired embodiment.

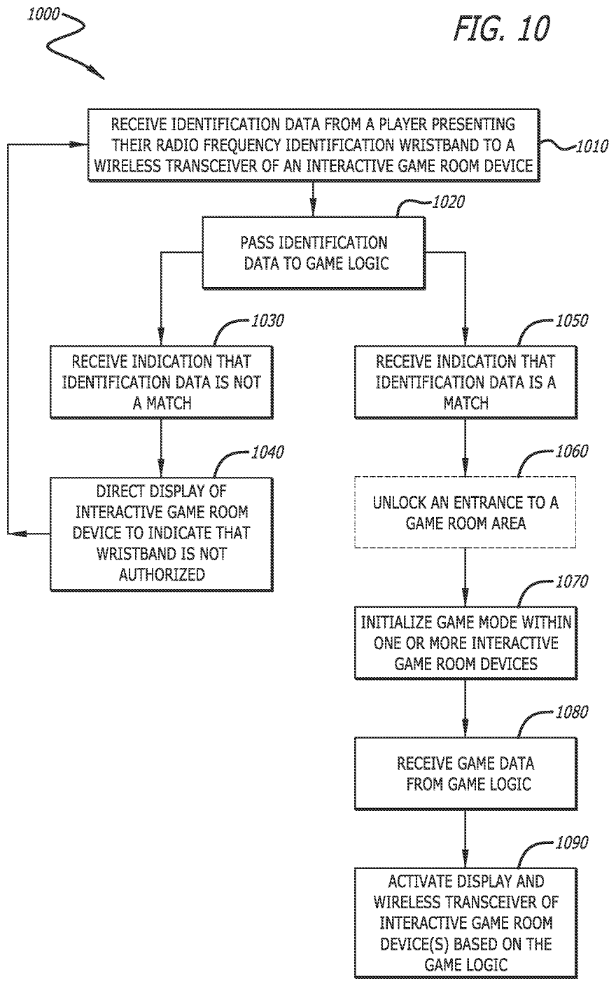

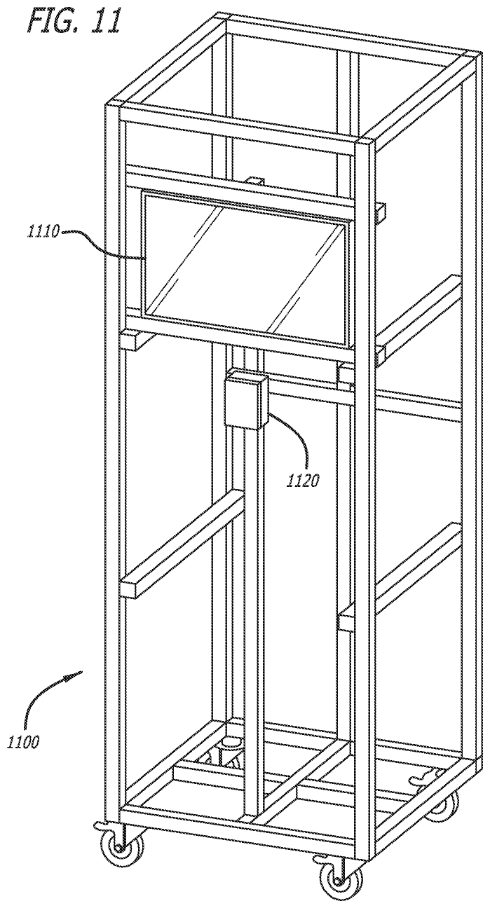

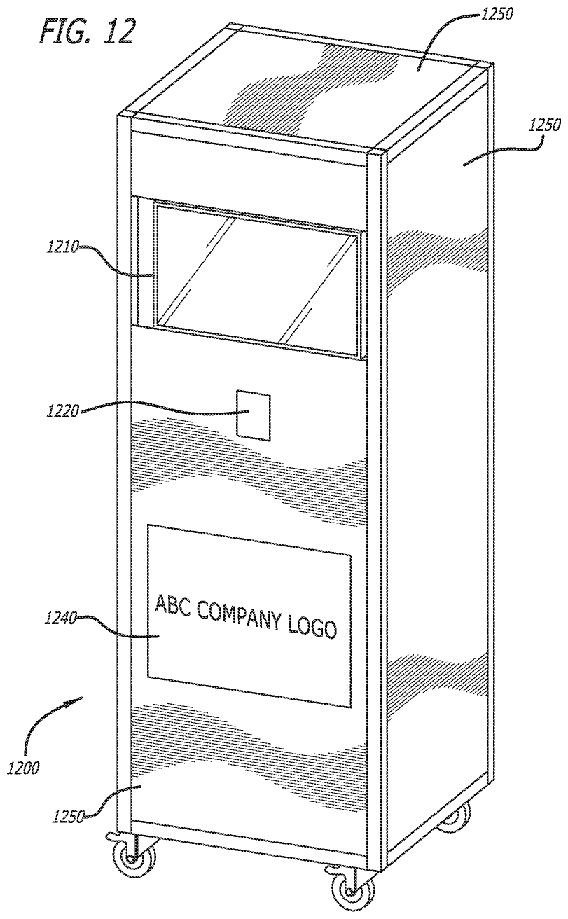

Referring to FIG. 10, a flowchart depicting a process 1000 for restricting access to a game room utilizing an interactive game room device is shown. In many embodiments, the process 1000 can receive identification data from a player presenting their radio frequency identification (RFID) wristband to a wireless transceiver of an interactive game room device (block 1010). As discussed above, in certain embodiments the wireless signal is from an RFID device, such as, but not limited to, an RFID bracelet. This can occur from a player who has placed an RFID bracelet next to the wireless sensor of an interactive game room device. In these embodiments, the wireless sensor can interact and receive data transmitted from the RFID bracelet or other wireless device and pass it to the game logic for further processing. However, as those skilled in the art will recognize, the wireless sensor may receive data from a number of wireless devices beyond an RFID device or transceiver.

In a number of embodiments, the process 1000 can pass identification data to a game logic (block 1020). The game logic can be processed within an interactive game room device. In further embodiments, the game logic can be processed within a specialized or other external device associated with the game room. As a result, passing the identification data to the game logic can be done via a function call, or other digital communication method depending on the links connecting the wireless sensor and the game logic. The interactive game room device can subsequently receive an indication if the received identification data is a match or not.

In some embodiments, the process 1000 can receive an indication that the identification data is not a match (block 1030). In these cases, the indication can simply be a function return value. In additional embodiments, the indication may also include specific data indicating why or what specifically was incorrect about the match. For example, the identification data may have been a match, but the time period for play within a game room may not yet have occurred.

In various embodiments, the process 1000 can direct a display of an interactive game room device to indicate that the wristband is not authorized (block 1040). Depending on the configuration of the game room and/or game logic, the process 1000 can direct the display of the interactive game room device to display one or more points of data. In certain embodiments the indication can be a display a specific color, text, or symbol on the display of the interactive game room device to indicate that the identification data received was not a match. Likewise, an audible noise, vibration from a haptic feedback device, and/or illumination of one or more light sources can also be configured to indicate the same. In these embodiments, additional data may be displayed to indicate what or why a match did not occur (incorrect location, player, time, etc.).

In more embodiments, the process 1000 can receive an indication that the identification data is a match (block 1050). Similar to the above, the indication can simply be a function return value. In additional embodiments, the indication may also include specific data indicating why or what specifically was correct about the match. The match criteria can change depending on the type of access being sought.

In optional embodiments, the process 1000 can unlock an entrance to a game room area (block 1060). In some game rooms, there may be locks present to better facilitate the flow of people through the game rooms in a multi-game room facility. For example, a game may have a first game within a first game room for fifteen minutes, followed by a second game within a second game room for another specified amount of time. Once the players leave the first game room to move to the second game room, the first game room can be reset and filled with another set of players to achieve maximum efficiency in game room usage. Therefore, it would be desired to restrict access to the game room until the correct players are within the correct timeframe for example.

In some embodiments, the locks to one or more doors to a game room or other gaming facility can be connected to a game logic or interactive game room device. In this way, the wireless sensor of the interactive game room device can be utilized to receive identification data from each player. The locks to the game room can be unlocked based on the players interactive with the wireless sensor of the interactive game room. In certain embodiments, the game logic may require a certain number of players to arrive and “check-in” by swiping or otherwise interacting with the wireless sensor of the interactive game room device with their personalized wireless device (e.g., RFID bracelet). In various embodiments, the game room may be unlocked when the first player or “captain” of a team is present and presents their identification data to the interactive game room device.

In further embodiments, the process 1000 can initialize a game mode within one or more interactive game room devices (block 1070). Subsequently to entry, a game logic may start a game and initialize a game mode within the game room, including a plurality of interactive game room devices. Each of the interactive game room devices may have a different game mode to start with. For example, some may require a “check-in” by one or more players. Others may request player data, and still others may display rules or other introductory info prior to starting the game.

In additional embodiments, the process 1000 can receive game data from a game logic (block 1080). As discussed above, the game logic may be, in certain embodiments, remotely or externally located on a different device apart from the interactive game room device. The game data received from a game logic can be configured as directions for the devices within the game room, such as the displays, lights, or other devices. Often, the game data will be formatted for the current game set up within the game room. However, those skilled in the art will recognize that game data can be received in numerous ways from one or more game logics.

In still more embodiments, the process 1000 can activate a display and wireless transceiver of an interactive game room device based on the game logic (block 1090). The game room may be equipped with a plurality of interactive game room devices. Each interactive game room device may itself be configured with at least a wireless sensor or transceiver, as well as a display. Upon receiving game data, the game logic can direct the interactive game room devices to engage in one or more activities to play the desired game. This can be a direction or passing of data to display on the various displays of the game room, or may be data to configure one or more lights, sensors, and/or elements to turn on in a certain way. For entering a game room, this activation can be an initialization of a game or the devices within a game room.

Although a specific embodiment for a process for restricting access to a game room utilizing an interactive game room device suitable for carrying out the various steps, processes, methods, and operations described herein is discussed with respect to FIG. 10, any of a variety of systems and/or processes may be utilized in accordance with embodiments of the disclosure. For example, access to the game room can be utilized to restrict access to start a game or can be to restrict access between multiple game rooms in a multi-room game. For example, one or more paths can be limited based on scores or other identification data received. The elements depicted in FIG. 10 may also be interchangeable with other elements of FIGS. 1-9 as required to realize a particularly desired embodiment.

Information Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An interactive game room device, comprising:
a wireless reader comprising:
a case;
a processor;
a wireless sensor;
a plurality of illumination devices; and
a communication port, wherein the communication port is coupled to a game logic; and
a display;
wherein the display is configured to interact with the game logic to display one or more current game states associated with the game logic on the display.

2. The interactive game room device of claim 1, wherein the game logic is configured to:
execute a game mode;
receive identification data associated with a wireless device;
determine a player association based on the received identification data;
adjust a game state based on the determined player association; and
direct the display to indicate the adjusted game state.

3. The interactive game room device of claim 2, wherein the identification data is received from the wireless sensor.

4. The interactive game room device of claim 3, wherein the wireless sensor receives the identification data in response to an interaction with the wireless device.

5. The interactive game room device of claim 4, wherein the wireless device is a wearable device.

6. The interactive game room device of claim 5, wherein the wearable device is a wristband.

7. The interactive game room device of claim 1, wherein the game logic is configured to:
receive game data;
generate a current game mode;
direct the display to indicate the current game mode;
receive wireless signal data;
parse the wireless signal data for identification data;
validate the identification data;
update the game mode based on the validated identification data; and
direct the display to indicate the updated game mode.

8. The interactive game room device of claim 7, wherein the wireless signal data is received from the wireless sensor in response to an interactive with a wearable device capable of wireless communication.

9. The interactive game room device of claim 1, wherein the wireless reader and display are deployed as separate devices within a game room.

10. The interactive game room device of claim 1, wherein the wireless reader and display are deployed within a single casing within a game room.

11. The interactive game room device of claim 1, wherein the wireless reader and display are both deployed on a pole within a game room.

12. The interactive game room device of claim 1, wherein the wireless sensor is a radio frequency identification sensor.

13. The interactive game room device of claim 1, wherein the display is a touchscreen display and inputs received by the touch screen display are receivable by the game logic.

14. The interactive game room device of claim 1, wherein the game logic is processed by the processor.

15. The interactive game room device of claim 1, wherein the communication port is further coupled to additional interactive game room devices within a single game room.

16. The interactive game room device of claim 15, wherein the game logic is processed by a processor in an additional interactive game room device.

17. The interactive game room device of claim 16, wherein the game logic is configured to initialize a game within the single game room utilizing the interactive game room device and additional interactive game room devices.

18. A method of conducting a game with an interactive game room device, comprising:
executing a game mode via a processor located in an interactive game room device;
receiving identification data via a wireless sensor located within the interactive game room device; wherein the identification data is associated with a player;
determining a player association based on the received identification data;
adjusting a game mode based on the determined player association; and
directing a display of the interactive game room device to indicate the adjusted game state.

19. An interactive game room device, comprising:
a wireless reader comprising:
a case;
a processor;
a wireless sensor;
a plurality of illumination devices; and
a communication port, wherein the communication port is coupled to a game logic; and
a touch-screen display;
wherein the display is configured to interact with the game logic to display one or more current game states associated with the game logic on the display.

20. The interactive game room device of claim 19, wherein the game logic is located within a memory associated with the interactive game display device.
